(19) United States
(12) Patent Application Publication
(10) Pub. No.: US 2007/0260983 A1
(43) Pub. Date: Nov. 8, 2007

(54) Method for providing a summary of user activities

(75) Inventor: Gaurav Wadhwa, Haryana (IN)

Correspondence Address: KENYON & KENYON LLP, RIVERPARK TOWERS, SUITE 600, 333 W. SAN CARLOS ST., SAN JOSE, CA, 95110, US

(73) Assignee: SAP AG, Walldorf (DE)

(21) Appl. No.: 11/418,783

(22) Filed: May 5, 2006

(51) Int. Cl. G06F 3/00

(52) U.S. Cl. 715/700

(57) ABSTRACT

A method for providing a work summary to a user of an electrical device. A work summary program may collect user activity information and save it in a work summary database. The user may choose a selection criterion from a group of selection criteria to indicate user activity information he would like to be included in the work summary. The work summary program may select user activity information from the work summary database according to the selection criterion and present a work summary to the user accordingly.

### BACKGROUND

With the development of computer and network technology, more and more transactions are now paperless. For example, a user could place and modify a purchase order with his computer.

Some application programs can keep a record or history of a document. For example, Word™ from Microsoft® keeps a record of which user made what changes to a document if the Track Changes function is turned on. iManage™ Document Management System from iManage Inc. could provide a history of a document. However, the available technology does not allow a user to select his activity information and filter presentation of his activities in a way he prefers. In addition, the user may work on a number of projects in parallel, but the available technology does not provide a summary of the user's activities in different projects. To find out whether he has placed an order, or updated a database, the user has to either keep a note for himself, or open different documents or application programs to double check. This is time-consuming and not user friendly.

In addition, when a number of users of a corporate computer system work on a common project, the conventional computer system does not allow one user to quickly find out his teammates' recent activities relating to this project.

Thus, it would be desirable to provide a summary of user activities in a computer system in the way the user prefers.

### BRIEF DESCRIPTION OF THE DRAWINGS

FIG. 1 is a simplified block diagram of an exemplary computer network in which embodiments of the present invention may find application.

FIG. 2 is a flow chart of a method for collecting data for a work summary database according to one embodiment of the present invention.

FIG. 3 is a flow chart of a method for collecting data for a work summary database according to another embodiment of the present invention.

FIG. 4 is a flow chart of a method for providing a work summary to a user of a computer system according to one embodiment of the present invention.

FIG. 5 shows a work summary configuring page according to one embodiment of the present invention.

FIG. 6 shows a work summary presented to a user of a computer system according to one embodiment of the present invention.

FIG. 7 shows a work summary presented to a user of a computer system according to another embodiment of the present invention.

### DETAILED DESCRIPTION OF EMBODIMENTS

The present invention collects and stores data representing user activity in a work summary database. When a user logs into a computer system, he could see a summary of his activities. The summary could be presented according to the user's selection, e.g., work done during the last login or last several logins, work done on a particular day or within a certain period of time, or work done related to a product, a project or a vendor, etc. More selection criteria could be used to meet business requirements.

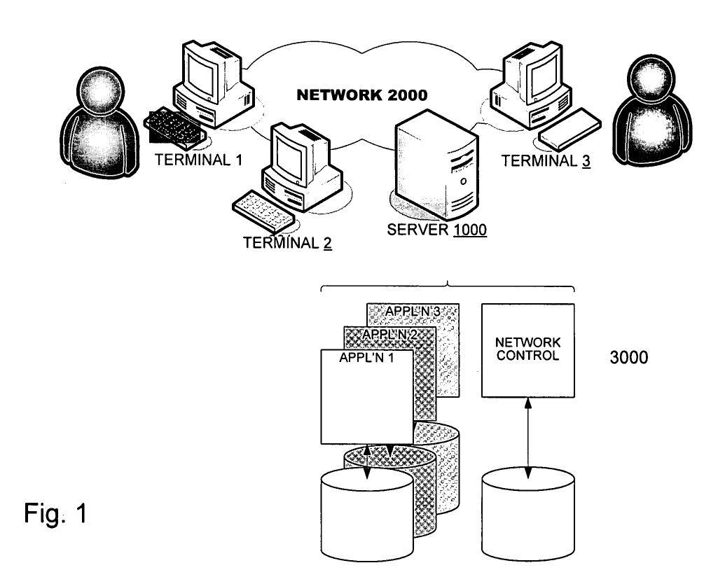

FIG. 1 is a simplified block diagram of an exemplary computer network in which embodiments of the present invention may find application. The illustrated network includes a number of terminals 1, 2 and 3 working over an integrated network 2000. Users may work at the various terminals and may be located at geographically diverse locations. The terminals 1-3 may be provided in communication with a server 1000, which may manage user activity data in a work summary database. The computer network may support a number of applications, storing data about users' activities in these applications into the work summary database. The computer network is maintained by a network control 3000.

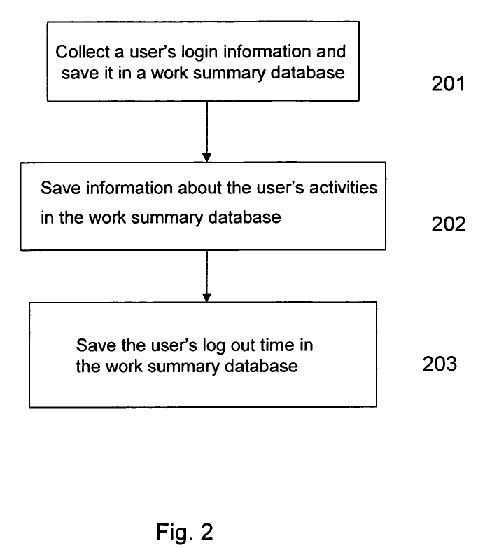

FIG. 2 is a flow chart of a method for collecting data for a work summary database according to one embodiment of the present invention. In the embodiment shown in FIG. 2, the user is an employee of a company and is assigned the role of Purchaser. He may log into a corporate computer system on Jun. 1, 2005. At 201, a work summary program may collect the user's log in information, such as his user name and log in time, and save the collected information in a work summary database.

The user may create a new purchase order PO12345 and save it. At 202, the work summary program may collect information about the user's activities and save the user activity information in the work summary database. The user activity information could be, for example, the time purchase order PO12345 is created, its creator, its document name, the product ordered, the name of the vendor, etc. The user may then cancel purchase order PO12100, and change the amount of products ordered in purchase order PO12200. The work summary program may collect and store relevant user activity information.

The user may then log out of the system. At 203, the work summary program stores the user's log out time in the work summary database. As discussed below, the time of user activity and the user's log in time and log out time could be used to select user activity information when the selection criterion is user activities during the last log in or a certain period of time.

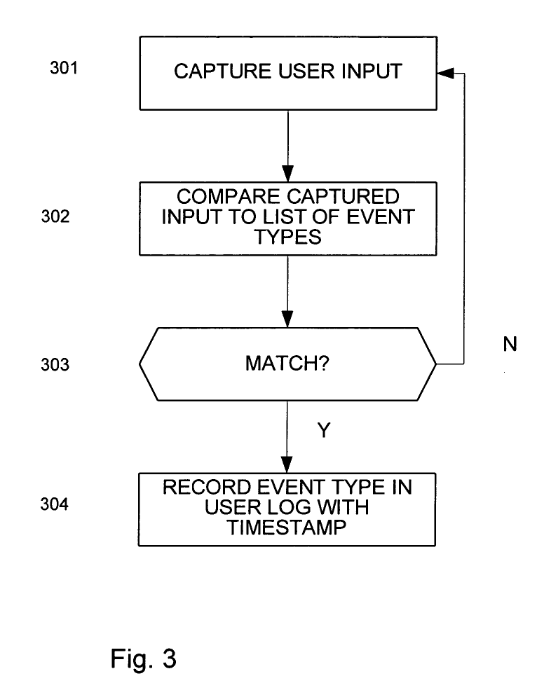

FIG. 3 is a flow chart of a method for collecting data for a work summary database according to another embodiment of the present invention. In this embodiment, the work summary program may keep a list of event types, and will store data about a user activity into the work summary database only if the user activity matches an event type in the list.

The work summary program may collect user activity data related to a business object. A business object is any documentary entity in a software system. One example of business object is a purchase order. Another example of business object is a sales contract. The business object has a lifecycle that is managed by the software system, so the software system knows what to do with the business object. For example, for a purchase order, the software system may know who can fill it out, who can make changes, who can approve it, etc. The software system may also know that its processes are different for a purchase order than for other types of business objects, e.g., a sales contract.

As shown, at 301, the work summary program may capture a user input. At 302, the work summary program may compare the captured user input with the list of event types. The list of event types may include milestones in the life of a business object. For example, for a purchase order, the event types may include: create, change, approve, delete, etc. If the work summary program finds a match between the user input and the list of event types at 303, it may store information about the user activity into the work summary database. Otherwise, the process may return to 301.

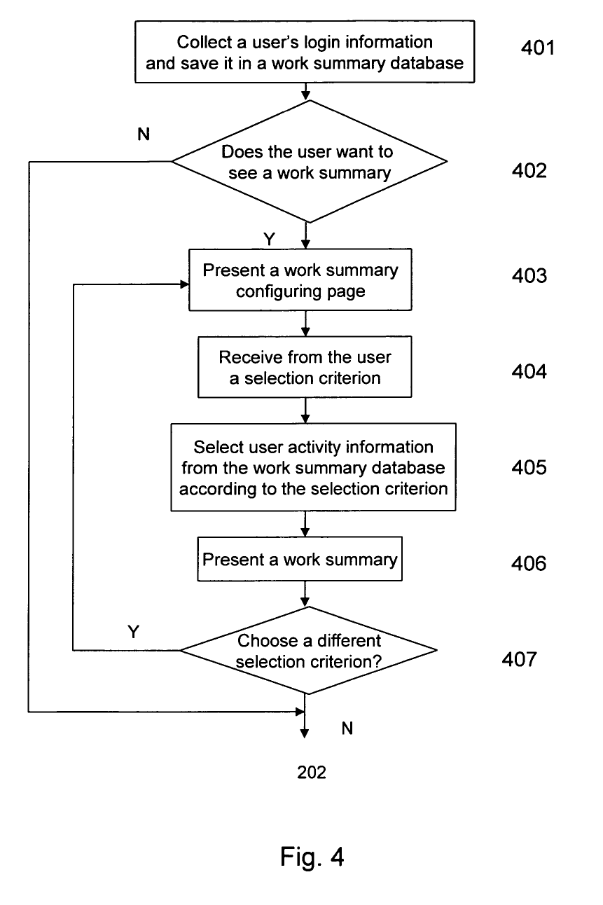

FIG. 4 is a flow chart of a method for presenting a work summary in a computer system according to one embodiment of the present invention. The user comes back to his office on Jun. 8, 2005 after a vacation and logs into the computer system again. At 401, the work summary program collects the user's log in information, such as his user name and log in time and saves the log in information into the work summary database.

At box 402, the work summary program presents a dialog window on the screen, asking whether the user would like to see a work summary. If the user chooses yes, at 403, the work summary program presents a work summary configuring page to the user, allowing him to choose selection criteria for arranging the work summary. The selection criteria could be, for example, the user's activities during the last log in or during the day before.

Alternatively, the user could set the work summary configuring page in advance, so that each time he logs in, a work summary will be shown on the screen automatically according to the default selection criteria.

Alternatively, when the user logs into the system, he will get a link to a page where he can see the summary of work done by him or other employees (authorization required) based on various selection criteria. If the user wants to see his work summary, he clicks on the link. The summary itself could include links to a underlying work product, e.g., a purchase order or a task approval, to facilitate navigation.

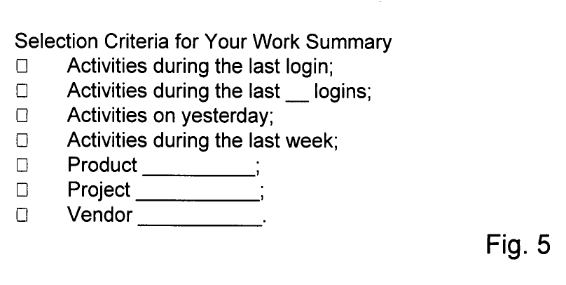

An example of the work summary configuring page is shown in FIG. 5. As shown, the selection criterion could be related to previous logins, like the user's activities during the last login or the last 5 logins. The selection criterion could be time based, for example, the user's activities during the day before, the week before, etc. The selection criterion could also be product based, project based or vendor based. The user activities to be shown in the work summary could also be decided by the system administrator.

If the user chooses no at step 402, the work summary program proceeds to box 202. As discussed above with reference to FIG. 2, when the user continues his operations, such as creating a new purchase order, or modifying data in a database, the user summary program may collect and save the user activities in the work summary database.

In one embodiment, the user chooses the selection criterion “Activities during the Last Login”. At 404, the work summary program may receive from the user the selection criterion. Accordingly, at 405, the work summary program may search the work summary database for user activity information according to the received selection criterion, e.g., during the last login.

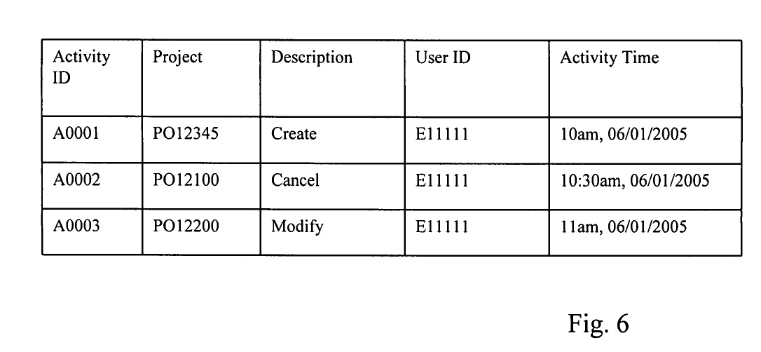

At 406, the work summary program may present to the user a work summary about the user's activities during the last login. The information in the work summary could be sorted, e.g., based on the time the activities occurred. The work summary includes the user activity information about purchase orders PO12345, PO12100 and PO12200. An example of the work summary is shown in FIG. 6. As shown, the work summary may include columns for Activity ID, Project, Activity Description, User ID, Activity Time, etc.

As to the purchase order PO12345, the Activity ID is A0001, Project is PO12345, Activity Description is Create, User ID is E11111, and Activity time is 10 am, Jun. 1, 2005. The work summary could also include a link to PO12345, the name of the ordered product and the name of the vendor.

As to the purchase order PO12100, the Activity ID is A0002, Project is PO12100, Activity Description is Cancel, User ID is E11111, and Activity time is 10:30 am, Jun. 1, 2005.

As to the purchase order PO12200, the Activity ID is A0003, Project is PO12200, Activity Description is Modify, User ID is E11111, and Activity time is 11 am, Jun. 1, 2005. The work summary could also include a link to PO12200, marking the changes made during the last log in.

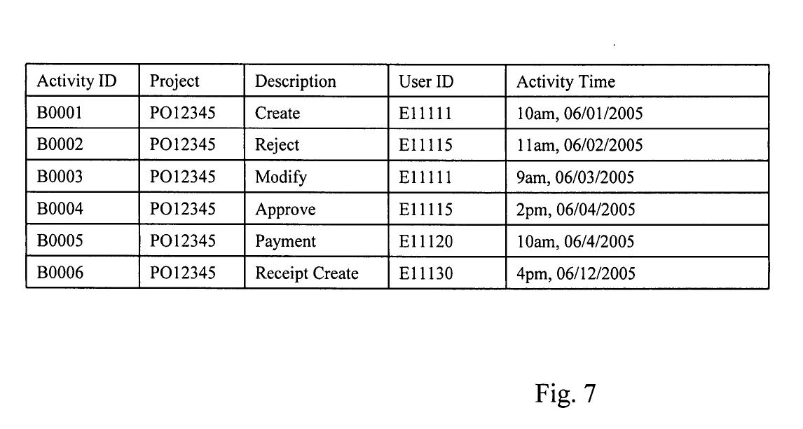

In the example shown in FIG. 7, the summary could also include co-workers' activities regarding a project, such as Purchase Order PO12345. The work summary may include columns for Activity ID, Project, Activity Description, User ID, Activity Time, etc.

PO12345 is created by user E11111 on Jun. 1, 2005, rejected by user E11115 on Jun. 2, 2005, modified by user E11111 on Jun. 3, 2005, and approved by user E11115 on Jun. 4, 2005. A payment related to PO12345 was made by user E11120 on Jun. 4, 2005, and a receipt of ordered products was created by user E11130 on Jun. 12, 2005.

It should be understood that the user could choose more than one selection criterion. For example, if the user chooses both his activities during the last login and all activities about PO12345, the work summary presented would be a combination of those shown in FIGS. 6 and 7. Consequently, the work summary program provides a record of the user's activities and his co-workers' activities, so that the user is clear what he has done and could easily move forward.

At 407, it is decided whether the user would like to review the work summary according to a different criterion. If yes, the process may return to 403. Otherwise, the process may proceed to 202.

The work summary database could be a part of the system database. In one embodiment, a table named “Table_User_Activity” is added to the system database. The Table_User_Activity could contain the following information:
Activity ID: Unique ID for an activity of a user;
Activity_Description: Description of the user's activity;
User_ID: User ID of the user who performed that activity;
Date_Time: Date_Timestamp at which the activity occurred;
Login_Count: Number of times that the user has logged into the system so far, which increases every time the user logs in;
Product: Product related to the activity;
Vendor: Vendor related to the activity; and
Project: Project related to the activity.
   More or less information could be included in the table to meet business requirements.

Every time a user performs an activity in the system, information about the activity will be stored in this table. User activities can be anything and everything that a user does in the system. For example, the activities can be the user logging into or logging out of the system, opening or closing some applications or screens in the system, accepting a task or rejecting a task, modifying or deleting data in the system, creating or modifying or deleting a purchase order, etc. When a user chooses a selection criterion, the work summary program may search the work summary database to select information corresponding to the selection criterion and show the selected information in a work summary. Selecting information from a database according to a selection criterion and presenting the selected information could be done according to any method known in the art or developed in future.

Accordingly, the work summary database enables the work summary program to display the work summary based on different selection criteria.

While the invention has been described in detail above with reference to some embodiments, variations within the scope and spirit of the invention will be apparent to those of ordinary skill in the art. For example, although embodiments are described with reference to a computer, other electrical device could be used.

1. A method for providing a work summary to a user of an electrical device, comprising:
collecting information about activities performed by the user with the electrical device;
storing collected user activity information in a work summary database;
selecting user activity information from the work summary database according to a selection criterion from the user; and
presenting to the user a work summary including the selected user activity information.

2. The method of claim 1, wherein the user activity is about a business object.

3. The method of claim 2, wherein the user activity is an approval event related to a business object.

4. The method of claim 3, wherein the business object is a purchase order.

5. The method of claim 1, further comprising presenting a work summary configuring page to the user.

6. The method of claim 1, wherein the work summary is created according to a default selection criterion chosen by the user.

7. The method of claim 1, wherein the selection criterion is the user's activities during the last login.

8. The method of claim 1, wherein the selection criterion is the user's activities during a certain period of time.

9. The method of claim 1, wherein the electrical device is coupled to a computer network.

10. The method of claim 9, wherein the selection criterion is activities about a project of all users of the computer network.

11. The method of claim 1, wherein the information in the work summary is related to at least two projects.

12. The method of claim 1, wherein the information in the work summary is related to at least two application programs.

13. The method of claim 1, further comprising receiving a second selection criterion from the user.

14. The method of claim 1, further comprising storing a list of event types.

15. The method of claim 14, further comprising comparing a user activity with the list of event types.

16. A computer program product containing program code for performing the method of claim 1.

17. A system, comprising:
a work summary database; and
a work summary program for collecting information about activities performed by a user with an electrical device, storing collected user activity information in the work summary database, selecting user activity information from the work summary database according to a selection criterion from the user, and presenting to the user a work summary including the selected user activity information.

18. The system of claim 17, wherein the user activity is about a business object.

19. A method, comprising:
during user interaction with a computer system, monitoring user activity with the computer system including times when the user is interacting with application programs and when the user is idle,
generating a log of the monitored user activity, the log identifying times of user interaction with the application programs, times of predetermined events with respect to work product of the application programs and times of predetermined events with respect to other computer services.

20. The method of claim 18, further comprising storing pointers in the log to work product items referenced therein that, when activated during subsequent review of the log, cause the work product to be opened in a corresponding application program.
